(19) United States
(12) Patent Application Publication
(10) Pub. No.: US 2008/0258963 A1
(43) Pub. Date: Oct. 23, 2008

(54) Compass aided direction finding for first responders

(76) Inventors: Ramakrishna S. Budampati, Maple Grove, MN (US); Arun V. Mahasenan, Bangalore (IN)

Correspondence Address: Bryan Anderson;Patent Services, Honeywell International Inc., 101 Columbia Road, Morristown, NJ, 07962, US

(21) Appl. No.: 11/788,628

(22) Filed: Apr. 20, 2007

(51) Int. Cl. G01S 1/00

(52) U.S. Cl. 342/147

(57) ABSTRACT

A direction finding system used with an exit having a transmitter at that exit sending a location beam having a direction with respect to a compass direction. A receiver is carried by a person seeking directional guidance to the exit. The receiver receives the beam and determines the direction of the beam with respect to the compass direction. A display indicates the direction in which the person should move to reach the exit. Either the transmitter or the receiver or both may use an antenna array for sending and/or receiving a plurality of signals, each having a specific direction with respect to the compass direction. In a preferred embodiment, the receiver corrects for differences between the sent direction and the actual direction received.

### FIELD OF THE INVENTION

The present invention relates to a low-cost, extremely-intuitive visual aide for fire fighters and the like. More particularly, the invention relates to the use of a fixed directional antenna at the safe exit point and a compass aided direction estimator adapted to receive a signal from the directional antenna and guide the user to the safe exit.

### BACKGROUND OF THE INVENTION

There are a number of devices currently available for firefighters, first responders and others entering a facility when it is in need of an emergency response such as from a fire, explosion, leaking gas or other hazardous materials. The devices include global positioning units, radio and RF communication components and other sophisticated technology. However, there remains a need to provide a low-cost, extremely-intuitive visual aide for such personnel to direct themselves toward a safe exit point in a building during an emergency.

The goal of any such device would be to get the personnel to a safe exit when there is no time for sophisticated technology to function. One such device adds to the traditional use of fire alarms to alert building occupants to a fire. A fire alarm alone is not designed to guide people out of a fire.

One product that modifies the fire alarm system is sold by Honeywell International Inc. under the trade name ExitPoint™ which uses directional sound technology to mark paths to safety. Varying tones and intensities from the devices, which are placed along escape routes, help lead occupants toward exits. Directional sound clearly communicates the location of exits using broadband noise. Exitpoint™ incorporates four different field selectable sound pulse patterns. The patterns consist of broadband noise, which makes it possible to locate where the sound is coming from. The four pulse patterns are used to create a pathway out of the building and mark its perimeter exits. The sound pattern becomes faster as the building occupant approaches the perimeter exit. Additional tone pulses can be added to the patterns to alert occupants that they are approaching a stairway and need to proceed either up or down.

There is still a need for a simple, economic device and method that would lead or guide persons at risk in a facility to a safe exit so that each person so under peril would have his or her own directions to the safe exit.

It would be of advantage in the art if a unit could be carried by a firefighter, first responder and the like that would point to a safe exit based on information carrying signals that can be simply and reliably converted into exit directions.

Yet another advantage would be if a device and method could be provided that would display an indication of the direction a user should take to a safe exit.

It would be another advance in the art if a device and method could be provided that would adjust or compensate for signals that are reflected, to further aid the user to move to a safe exit.

Other advantages will appear hereinafter.

### SUMMARY OF THE INVENTION

It has now been discovered that the above and other advantages of the present invention may be obtained in the following manner. Specifically, the present invention provides a direction finding device for finding the direction to an exit for a person in a facility. The invention includes one or more safe exits in a facility having a source transmitting an electromagnetic beam having direction information with respect to a compass direction. A receiver unit carried by a person in the facility receives the beam from the source and determines the direction of arrival of the beam with respect to the compass direction. In the display a direction is shown for the person to move toward the exit, such as by illuminating an arrow pointing to the safe exit.

The beam containing the direction information may be any electro-magnetic wave or beam, and preferably is selected from the group consisting of an RF beam, an ultrasound beam and combinations there of.

The source beam may be an omni-directional beam and the receiver unit may use an antenna array for selectively receiving the omni-directional beam to determine the angle at which the beam is received. Alternatively the source can be an antenna array sending a plurality of beams, each of which contains specific information of its direction with respect to the compass direction and the receiver includes a single antenna to determine which of the plurality of beams is the received beam.

When the source is an antenna array and the receiver unit includes an antenna array for selectively receiving the beam, the means for determining the direction of the received beam is used to determine a direction corrected for any difference between the information direction and the received direction.

### BRIEF DESCRIPTION OF THE DRAWINGS

For a more complete understanding of the invention, reference is hereby made to the drawings, wherein like numbers refer to like elements, and in which:

FIG. 1 is a schematic diagram illustrating the principles of the present invention;

FIG. 2 is a block diagram of one component of the invention shown in FIG. 1; and

FIG. 3 is a schematic diagram illustrating a preferred embodiment of the present invention.

### DETAILED DESCRIPTION OF THE PREFERRED EMBODIMENT

The invention is directly related to providing directions for exit in times of emergency or danger in the facility, such as from fire, smoke, pollution, and other events which are unsafe. Firefighters, first responders, emergency medical technicians and the like may enter a facility during an emergency and when that emergency escalates, those personnel need to evacuate as quickly as possible, even under circumstances of significantly reduced vision. Specifically the user is provided with direction information that identifies the coordinates of the beam with respect to north and east, for example, and the display of the direction is also shown in relation to the same coordinates.

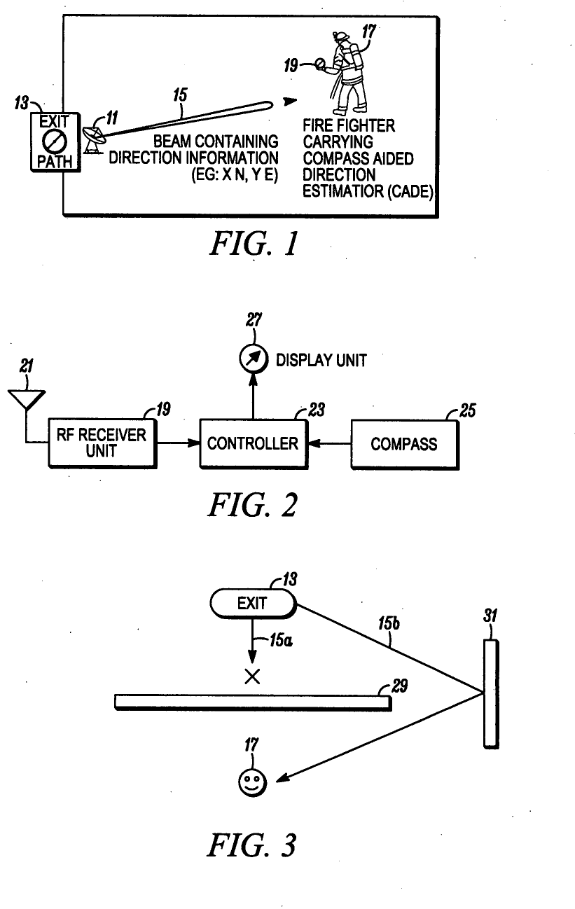

As shown in FIG. 1, a transmitter 11 is located proximate at least one safe exit 13, transmitting a beam or signal 15. Any electro-magnetic signal that is not too adversely affected by heat, smoke, dust and the like can be used as long as it can carry information in the signal. Preferred signals are RF and ultrasound and combinations of both of those signals. Any electro-magnetic signal has its own constraints and benefits. For example, ultrasound does not travel great distances, but is useable to detect multi-paths. It is also affected by humidity, pressure, heat, the specific atmosphere or medium through which it is transmitted.

As seen in FIG. 1 the beam or signal 15 is received by a person 17, such as a fire fighter as shown therein, who is carrying a receiver 19. In FIG. 1, signal 15 has a direction x with respect to, for example, north and east on a compass coordinate. Receiver 19 includes a signal receiving component or antenna 21, which relays the received signal 15 to a controller 23 that identifies the specific direction of signal 15 with respect to coordinates of a compass 25 as shown in FIG. 2. the controller 23 then informs display unit 27 to display the appropriate direction by arrow on display 27.

Even if the person 17 turns left or right, or rotates, the arrow in display 27 will continue to point to exit 13 in response to signal 15, because the signal 15 and the arrow in display 27 are both identified by coordinates that are based on the compass direction.

Signal 15 may be generated by transmitter 11 in several ways. The transmitter may employ an omni-directional antenna to transmit beacons, in all 360°, and the antenna 21 of receiver 19 may be an antenna array adapted to receive many signals and identify the one signal that comes directly into the antenna array. This embodiment may lose some accuracy when the signal 15 is not in direct line of sight from the transmitter 11 to the receiver 19, but, rather, has bounced off walls or other objects.

Alternatively, transmitter 11 may use directional antennas at exit 13 to transmit one beacon at a time with the appropriate direction information for that direction. Antenna 21 of receiver 19 could then be an omni-directional antenna so the controller used the data in signal 15 to determine the direction for display 27 to show. However, this embodiment does not provide for the person 17 to verify that the signal with the highest RSSI value is the direct LOS signal. In FIG. 3, exit 13 has transmitted signals 15a and 15b, for simplicity, and a wall 29 is in the way of direct line of sight transmission of signal 15a. Signal 15b is reflected off another wall 31 and received by the person 17. With an omni-directional antenna, this leads to a misdirection toward wall 31. Of course, when the person 17 gets to the opening between walls 29 and 31, the true signal will be received and display 27 will then point to exit 11.

In a preferred embodiment, both the transmitter 11 and antenna 21 are antenna arrays and send receive a plurality of beacons, each with the correct coordinates with respect to the compass. Controller 21 is programmed to compare the angle of arrival with the advertised angle in the data in signal 15b. If they are the same angle, person 17 knows that display 27 is indicating a direct path to exit 13. If they are not the same, person 17 therefore knows that the angle is a reflected signal and the controller 21, with or without indicating to person 17 that it has done so, will display a direction based on the adjustment to the compass coordinates for the signal. Person 17 goes in the direction of receipt until receiver 19 has received a direct line of sight signal.

While particular embodiments of the present invention have been illustrated and described, it is not intended to limit the invention, except as defined by the following claims.

1. A direction finding system for finding the direction to an exit for a person in a facility, comprising:
an exit having a source transmitting an electro-magnetic beam at said exit, said beam having direction information with respect to a compass direction;
a receiver unit carried in said facility, said receiver unit being adapted to receive said beam from said source, said receiver unit including means for determining the direction of said beam with respect to said compass direction. and
a display operably connected to said receiver unit for displaying a direction for said person to move toward said exit.

2. The system of claim 1, wherein said beam containing said direction information is selected from the group consisting of an RF beam, an ultrasound beam and combinations there of.

3. The system of claim 1, wherein said source is an omni-directional beam and said receiver unit includes an antenna array for selectively receiving said omni-directional beam to determine the angle at which said beam is received.

4. The system of claim 1, wherein said source is an antenna array sending a plurality of directional beams, each of which contains specific information of its direction with respect to said compass direction.

5. The system of claim 4, wherein said receiver unit includes a single antenna and said unit determines which of said plurality of beams is the received beam.

6. The system of claim 1, wherein source is an antenna array sending a plurality of directional beams, each of which contains specific information of its direction with respect to said compass direction and said receiver unit includes an antenna array for selectively receiving said directional beam to determine the angle at which said beam is received.

7. The system of claim 6, wherein said means for determining the direction of said received beam with the information direction indicated by said received beam to determine a direction corrected for any difference between the information direction and the received direction.

8. A direction finding system for finding the direction to an exit for a person in a facility, comprising:
an exit having a source means for transmitting an electro-magnetic beam, said beam having direction information with respect to a compass direction;
a receiver unit means in said facility for receiving said beam from said source, said receiver unit means including means for determining the direction of said beam with respect to said compass direction. and
a display means operably connected to said receiver unit for displaying a direction for said person to move toward said exit.

9. The system of claim 8, wherein said beam containing said direction information is selected from the group consisting of an RF beam, an ultrasound beam and combinations there of.

10. The system of claim 8, wherein said source means includes an omni-directional beam and said receiver unit means includes an antenna array means for selectively receiving said omni-directional beam to determine the angle at which said beam is received.

11. The system of claim 8, wherein said source means is an antenna array sending a plurality of directional beams, each of which contains specific information of its direction with respect to said compass direction.

12. The system of claim 11, wherein said receiver unit means includes a single antenna and said unit determines which of said plurality of beams is the received beam.

13. The system of claim 1, wherein source means is an antenna array sending a plurality of directional beams, each of which contains specific information of its direction with respect to said compass direction and said receiver unit means includes an antenna array for selectively receiving said directional beam to determine the angle at which said beam is received.

14. The system of claim 13, wherein said means for determining the direction of said received beam with the information direction indicated by said received beam to determine a direction corrected for any difference between the information direction and the received direction.

15. A method finding the direction to an exit for a person in a facility, comprising:
mounting a source means at an exit for transmitting an electro-magnetic beam, said beam having direction information with respect to a compass direction;
receiving said beam from said source in a unit in said facility and determining the direction of said beam with respect to said compass direction. and displaying a direction for said person to move toward said exit.

16. The method of claim 15, wherein said beam containing said direction information is selected from the group consisting of an RF beam, an ultrasound beam and combinations there of.

17. The method of claim 15, wherein said source is transmitted from an omni-directional beam and said receiver selectively receives said omni-directional beam to determine the angle at which said beam is received.

18. The method of claim 15, wherein said source uses an antenna array sending a plurality of directional beams, each of which contains specific information of its direction with respect to said compass direction and said receiver unit means includes a single antenna and said unit determines which of said plurality of beams is the received beam.

19. The method of claim 15, wherein source means is sent by an antenna array sending a plurality of directional beams, each of which contains specific information of its direction with respect to said compass direction and said receiver unit uses an antenna array for selectively receiving said directional beam to determine the angle at which said beam is received.

20. The method of claim 19, wherein the direction of said received beam is compared with the information direction indicated by said received beam to determine a direction corrected for any difference between the information direction and the received direction.
